(19) United States
(12) Patent Application Publication
(10) Pub. No.: US 2018/0285949 A1
(43) Pub. Date: Oct. 4, 2018

(54) SYSTEM AND METHOD FOR PRESENTING CONTENT ON CLIENT DEVICES

(71) Applicant: Cognant LLC, Mountain View, CA (US)

(72) Inventors: Ethan Anderson, Mountain View, CA (US); Michael Migliero, San Mateo, CA (US)

(21) Appl. No.: 15/925,984

(22) Filed: Mar. 20, 2018

Related U.S. Application Data
(60) Provisional application No. 62/477,712, filed on Mar. 28, 2017.

(51) Int. Cl. G06Q 30/06; G06F 17/30

(52) U.S. Cl. CPC G06Q 30/0601; H04L 67/06; G06F 17/30867

(57) ABSTRACT

Implementations of the present disclosure are directed to a method, a system, and an article for providing content on client devices. An example computer-implemented method can include: providing an offer unit on a client device; presenting, using the offer unit, an offer to provide content on the client device; receiving, using the offer unit, an acceptance of the offer on the client device; completing, using the offer unit, a transaction based on the accepted offer; connecting, based on the completed transaction, the client device with a server configured to provide the content; and providing the client device with access to the content.

### CROSS-REFERENCE TO RELATED APPLICATIONS

This application claims the benefit of U.S. Provisional Patent Application No. 62/477,712, filed Mar. 28, 2017, the entire contents of which are incorporated by reference herein.

### BACKGROUND

The present disclosure relates generally to digital content and, in some examples, to systems and methods for presenting digital content on client devices.

Client devices are generally capable of presenting a wide variety of content, including images, video, audio, or combinations thereof. Such content can be stored locally on client devices and/or can be sent to the client devices from server computers over a network (e.g., the Internet). To watch an online movie, for example, a user of a client device can download a copy of the movie and/or can stream the movie from a content provider.

In certain instances, users can be presented with offers to view or otherwise experience content on client devices. When a user accepts an offer, the user can be required to complete one or more tasks or transactions associated with the offer, before the content becomes accessible. This can involve directing the client device to multiple websites (e.g., an appstore and/or a content provider's website) and/or downloading or running one or more software applications. The process can be time consuming and can lead to user frustration and/or abandonment of the transaction. Additionally or alternatively, due to the number of steps and the time involved, it can be difficult to monitor or track the process from the initial offer to the content presentation. This can prevent content providers or other entities from being able to attribute the content presentation to the initial offer.

### SUMMARY

In general, the subject matter described herein can be used to configure the presentation of content on client devices. An offer unit (e.g., a software package) can be provided on a client device. The offer unit can present an offer to provide content to a user of the client device. The user can interact with the offer unit to accept the offer and/or complete a task or transaction associated with the offer, in exchange for receiving the content. Once the task or transaction has been completed, the offer unit can provide the client device with access to the content.

Advantageously, the systems and methods described herein can significantly reduce the computation times, the number of computational steps, and/or the number of network hops associated with presenting the offer, completing the task or transaction, and/or presenting the content on the client device. In preferred examples, the user is able to accept the offer and complete any necessary tasks or transactions by interacting with the offer unit and without having to use or visit other software applications or websites. The approach can greatly simplify the process for users and minimize user frustration. This can make it more likely that a user will accept the offer and complete any necessary tasks or transactions required to receive the content. Additionally or alternatively, the reduction in computation times, the number of steps, and/or the number of network hops can make it easier to associate the content with the initial offer. For example, a provider of the content can more easily monitor or track the client device during the time between the offer presentation and the content presentation. Such tracking is more difficult with prior approaches, due to the longer computation times, increased processing steps, and/or additional network hops.

In one aspect, the subject matter described in this specification relates to a computer-implemented method. The method includes: providing an offer unit on a client device; presenting, using the offer unit, an offer to provide content on the client device; receiving, using the offer unit, an acceptance of the offer on the client device; completing, using the offer unit, a transaction based on the accepted offer; connecting, based on the completed transaction, the client device with a server configured to provide the content; and providing the client device with access to the content.

In certain examples, the offer unit can be initiated from a first software application running on the client device. The offer unit can include a graphical user interface configured to present the offer, receive the acceptance, and complete the transaction. The graphical user interface can include at least one selectable graphical element. The content can include a second software application, a video, an image, text, music, a game, and any combination thereof. The content can include a second offer unit configured to present a second offer to provide second content on the client device.

In various implementations, completing the transaction can include determining that a user of the client device has performed a task in exchange for receiving the content. The server can be configured to provide the content from a website and/or a third software application. Providing the client device with access to the content can include streaming the content to the client device and/or sending a content file to the client device. The method can include configuring the offer based on a user habit, a user interest, a user activity, a user history, a geographical location, a demographic feature of the user, or any combination thereof.

In another aspect, the subject matter described in this specification relates to a system. The system includes one or more computer processors programmed to perform operations including: providing an offer unit on a client device; presenting, using the offer unit, an offer to provide content on the client device; receiving, using the offer unit, an acceptance of the offer on the client device; completing, using the offer unit, a transaction based on the accepted offer; connecting, based on the completed transaction, the client device with a server configured to provide the content; and providing the client device with access to the content.

In some examples, the offer unit can be initiated from a first software application running on the client device. The offer unit can include a graphical user interface configured to present the offer, receive the acceptance, and complete the transaction. The graphical user interface can include at least one selectable graphical element. The content can include a second software application, a video, an image, text, music, a game, and any combination thereof. The content can include a second offer unit configured to present a second offer to provide second content on the client device.

In certain implementations, completing the transaction can include determining that a user of the client device has performed a task in exchange for receiving the content. The server can be configured to provide the content from a website and/or a third software application. Providing the client device with access to the content can include streaming the content to the client device and/or sending a content file to the client device. The operations can include configuring the offer based on a user habit, a user interest, a user activity, a user history, a geographical location, a demographic feature of the user, or any combination thereof.

In another aspect, the subject matter described in this specification relates to an article. The article includes a non-transitory computer-readable medium having instructions stored thereon that, when executed by one or more computer processors, cause the computer processors to perform operations including: providing an offer unit on a client device; presenting, using the offer unit, an offer to provide content on the client device; receiving, using the offer unit, an acceptance of the offer on the client device; completing, using the offer unit, a transaction based on the accepted offer; connecting, based on the completed transaction, the client device with a server configured to provide the content; and providing the client device with access to the content.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for providing content on client devices.

FIG. 2 is a schematic diagram of an example method of providing content on a client device.

FIG. 3 is a schematic diagram of an example method of providing content on a client device.

FIG. 4 is a schematic data flow diagram of an example method of providing content on a client device.

FIG. 5 is a flowchart of an example method of providing content on a client device.

### DETAILED DESCRIPTION

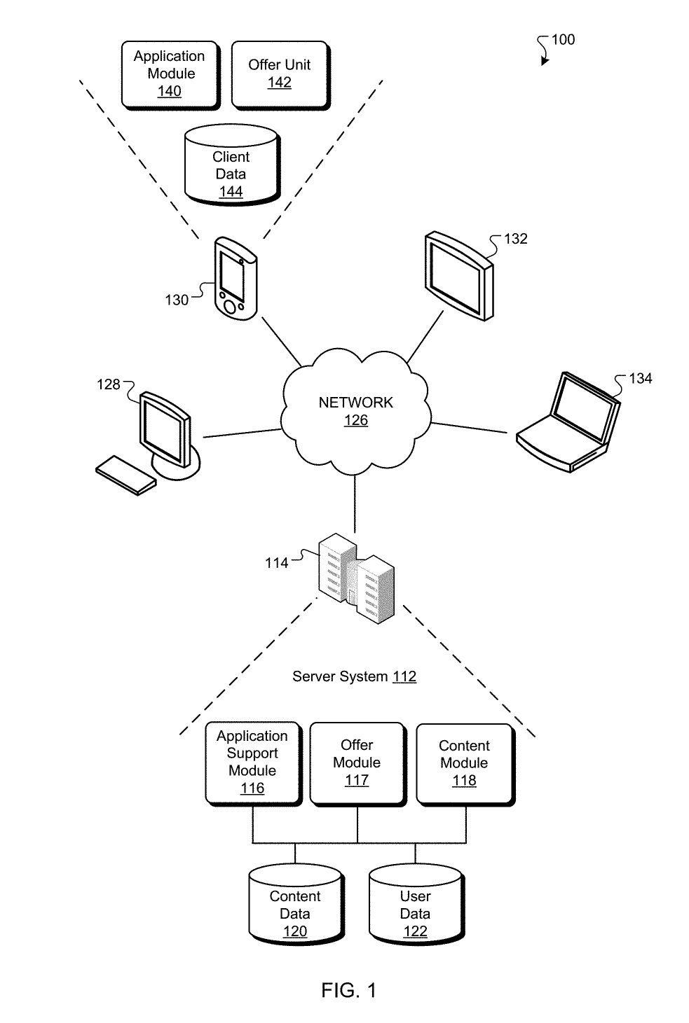

FIG. 1 illustrates an example system 100 for providing content (e.g., video, audio, images, text, software applications, books, subscriptions, goods, services, or any combinations thereof) on client devices. A server system 112 provides functionality for providing the content and/or for supporting a software application running on the client devices. The server system 112 includes software components and databases that can be deployed at one or more data centers 114 in one or more geographic locations, for example. The server system 112 software components can include an application support module 116, an offer module 117, and a content delivery module 118. The software components can include subcomponents that can execute on the same or on different individual data processing apparatus. The server system 112 databases can include content data 120 and user data 122 databases. The databases can reside in one or more physical storage systems. The software components and data will be further described below.

The software application can be a web-based application and/or can be provided as an end-user application to allow users to interact with the server system 112. The end-user application can be accessed through a network 126 (e.g., the Internet) by users of client devices, such as a personal computer 128, a smart phone 130, a tablet computer 132, and a laptop computer 134. Other client devices are possible. In alternative examples, the content data 120 and/or the user data 122 or any portions thereof can be stored on one or more client devices.

Each client device in the system 100 can utilize or include software components and databases for providing the software application and/or presenting the content. The software components on the client devices can include an application module 140, which can implement the software application on each client device. The software components on the client devices can also include an offer unit 142, which can present offers to provide content on the client devices and enable users to view the content on the client devices. The databases on the client devices can include a client data 144 database which can store content or data (e.g., for the software application) and exchange the content or data with the application module 140. The data stored on the client data 144 database can include, for example, user data, image data, video data, and any data or content used or generated by the application module 140, the offer unit 142, the offer module 117, and/or the content module 118. While the application module 140, the offer unit 142, and the client data 144 database are depicted as being associated with the smart phone 130, it is understood that other client devices (e.g., the personal computer 128, the tablet computer 132, and/or the laptop computer 134) can include the application module 140, the offer unit 142, the client data 144 database, and any portions thereof.

In some examples, the application support module 116 includes one or more software components that support the software application by, for example, performing calculations, implementing software updates, exchanging information, content, or data with the application module 140, and/or monitoring an overall status of the software application. The offer module 117 can be used to offer content for presentation on the client devices 128, 130, 132, and 134 and to complete transactions associated with the content, as described herein. In preferred examples, the offer module 117 can offer the content and complete the transactions by configuring and/or implementing the offer unit 142 on the client devices 128, 130, 132, and 134. The content module 118 is generally configured to deliver content to the client devices 128, 130, 132, and 134, for example, based on requests for content received from the offer module 117 and/or the offer unit 142. The content module 118 can retrieve the content from the content data 120 database.

FIG. 1 depicts the application support module 116, the offer module 117, and the content module 118 as being able to communicate with the databases (e.g., the content data 120 and the user data 122 databases). The content data 120 database generally includes the content, data, and/or a portion thereof that can be presented on the client devices 128, 130, 132, and 134. The data stored in the content data 120 database can include, for example, videos, images, audio, text, software, and any combination thereof. The user data 122 database generally includes information related to user interactions with the client devices 128, 130, 132, and 134 and/or the server system 112. Such information can be or include, for example, a history of user connections to and/or interactions with the system 100, a history of content presented to users, user purchases, user accomplishments, user tasks, and/or user interactions with other users (e.g., group chats). While FIG. 1 depicts the offer module 117 and the content module 118 as being part of the server system 112, it is understood that the offer module 117, the content model 118, or any portions thereof can reside on or be implemented by the client devices 128, 130, 132, and 134.

The software application implemented on the client devices 128, 130, 132, and 134 can relate to and/or provide a wide variety of functions and information, including, for example, entertainment (e.g., a game, music, images, videos, etc.), business (e.g., word processing, accounting, spreadsheets, etc.), news, weather, finance, sports, web browsing, etc. In certain instances, the software application provides a multi-player online game.

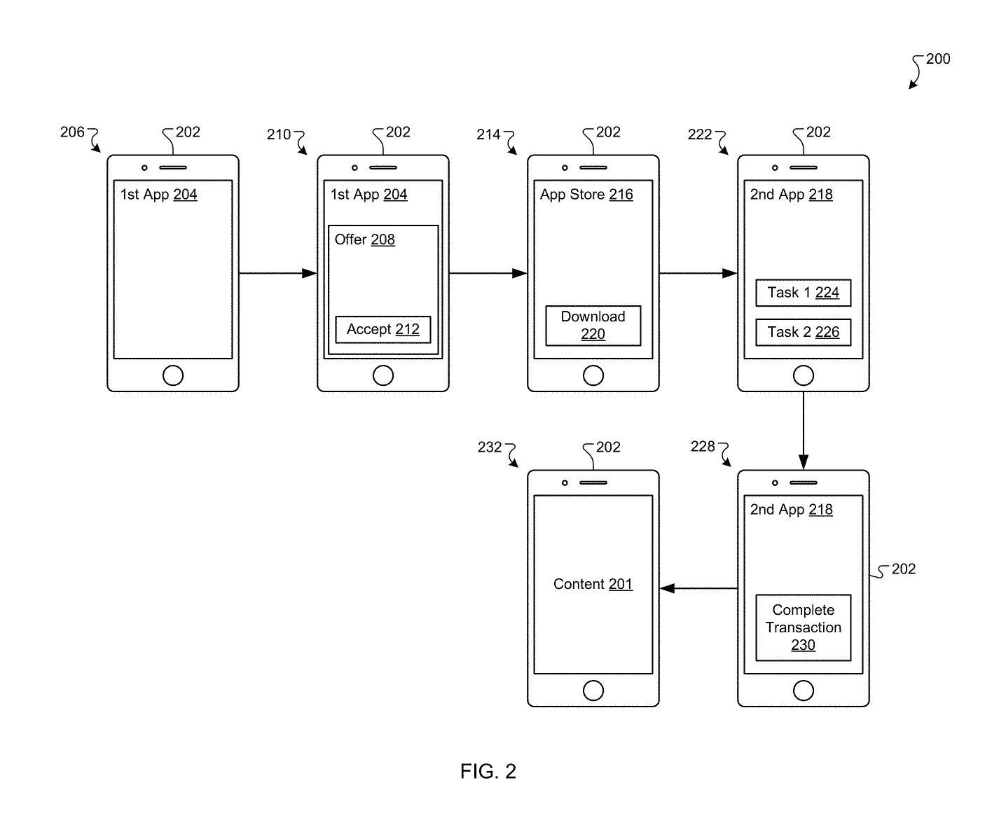

Referring to FIG. 2, in certain examples, a method 200 of offering and presenting content 201 on a client device 202 (e.g., the smart phone 130) can begin when a first software application 204 is running (step 206) on the client device 202 and an offer 208 is presented (step 210) on the client device 202. In general, the offer 208 can be or include a request or a suggestion for a user of the client device 202 to receive content 201 on the client device 202. A graphical user interface for the offer 208 can include one or more selectable graphical elements that the user can select to indicate that the offer 208 has been accepted or rejected. In the depicted example, the offer 208 includes a graphical element 212 that the user can select to accept the offer 208. Once the offer 208 is accepted, the client device 202 can be directed to and can display (step 214) an app store 216 or other website where the user can download a second software application 218 to view or receive the content 201. The user can initiate the download by selecting a graphical element 220 from the app store 214. After the download is complete and the second software application 218 is installed, the second software application 218 can present (step 222) the user with one or more tasks that the user can perform to receive the content 201. In the depicted example, a graphical user interface for the second software application indicates that the user can select either a first task 224 or a second task 226 to receive the content 201. The first task 224 and/or the second task 226 can be or include, for example, a transaction that can include viewing secondary content, playing a support game or a mini game, selecting a payment option, making a payment, or any combination thereof. Other suitable tasks are possible. After selecting a graphical element associated with the first task 224 or the second task 226, the second software application 218 can present (step 228) a graphical element 230 that allows the user to complete the transaction associated with the selected task. The transaction can be completed, for example, by viewing the secondary content, playing the support game or the mini game, selecting the payment option, making the payment, or any combination thereof. When the user selects the graphical element 230, the content 201 can be presented (step 232) on the client device 202, for example, using the second software application 218.

In various examples, the second software application can relate to and/or provide a wide variety of functions and information, including, for example, entertainment (e.g., a game, music, images, videos, etc.), business (e.g., word processing, accounting, spreadsheets, etc.), news, weather, finance, sports, web browsing, etc. In certain instances, the software application is configured to present content (e.g., videos, images, audio, and any combination thereof).

In certain instances, the task performed by the user (e.g., the first task 224 or the second task 226) can require the user to take a certain action in exchange for receiving the content 201. The task can involve a mental task and/or a physical task (e.g., answering questions, taking a survey, completing an application, watching a video, playing a video game). In some examples, the task can include making a payment (e.g., with a credit card).

In general, the method 200 can involve a relatively large number of steps and/or can require the client device 202 to run multiple software applications, perform multiple network hops, and/or visit multiple webpages before the content 201 is finally presented on the client device 202. The multiple steps can be time consuming and/or cumbersome from the user's perspective. Additionally or alternatively, given the number of steps, software applications, network hops, and/or webpages involved with the method 200, it can be difficult to link or associate the content 201 with the initial offer 208. By the time the user completes the transaction at step 228, for example, it can be difficult for a provider of the content 201 to determine that the user arrived at the content 201 by viewing and accepting the offer 208.

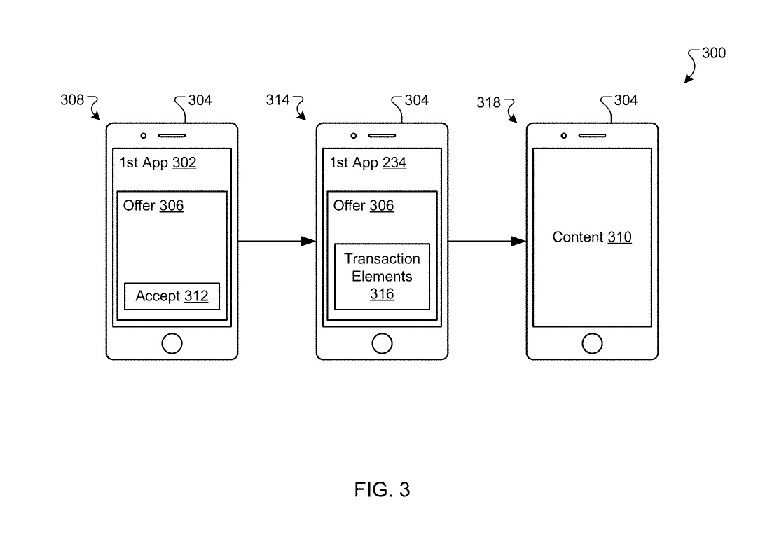

Referring to FIG. 3, in certain examples, a method 300 provides a more efficient approach for offering and providing content on client devices. The method 300 can begin when a first software application 302 is running on a client device 304 (e.g., the smart phone 130) and an offer 306 is presented (step 308) on the client device 304. In general, the offer 306 can be or include a request or a suggestion for a user of the client device 304 to receive content 310 on the client device 304. A graphical user interface for the offer 306 can include one or more selectable graphical elements that the user can select to indicate that the offer 306 has been accepted or rejected. In the depicted example, the offer 306 includes an acceptance element 312 that the user can select to accept the offer 306. Once the offer 306 is accepted, the graphical user interface for the offer 306 can present (step 314) one or more transaction elements 316 that allow the user to complete a transaction associated with the offer 306. For example, the transaction elements 316 can present the user with one or more tasks (e.g., the first task 224 or the second task 226) that the user can perform to receive the content 310. Additionally or alternatively, the transaction elements 316 can present the user with an option to complete a transaction (e.g., watching a video, playing a support game or a mini game, or making a payment) associated with the content 310. When the user selects the transaction elements 316, performs the tasks, and/or completes the transaction, the client device 304 can be automatically directed to and can display (step 318) the content 310. Additionally or alternatively, rather than displaying the content 310 automatically at this stage, the client device 304 can be directed to a website or online store (e.g., an app store or other mobile marketplace) where the user can download or otherwise obtain the content 310. The content 310 can be or include, for example, a second software application.

In various examples, the offer 306, the acceptance element 312, the transaction elements 316, and any combination thereof can be implemented using the offer unit 142 and/or the offer module 117. In general, the offer unit 142 and/or the offer module 117 can be or include a software package configured to present the offer 306, receive acceptance of the offer 306, complete a transaction with the user, and provide the client device 304 with access to the content. In some instances, for example, the offer unit 142 can be or include a software package that runs on the client device 304, and the offer module 117 can be or include a software package that runs on the server system 112. The offer unit 142 and/or the offer module 117 can perform these tasks while displaying a graphical user interface for the offer 306 on the client device 304 and/or preferably without having to direct the client device 304 to a website (e.g., online store) where additional steps are taken (e.g., as in the method 200) before the content 310 can be presented. In other words, all steps between presenting the offer 306 and completing the transaction can be performed using the offer unit 142 and/or the offer module 117, preferably using the graphical user interface for the offer 306. This can allow the user to perform all steps necessary to complete the transaction (e.g., offer acceptance, tasks, and/or transaction completion) from within the offer 306 itself, for example, while the graphical user interface for the offer 306 is being displayed on the client device.

Advantageously, compared to the method 200, the method 300 can greatly reduce the number of steps, the number of network hops, and/or the computation time required to process the offer 306, complete the transaction, and display the content 310. In certain instances, for example, the client device 304 can reduce or eliminate certain or all network hops required to accept the offer 306 and complete the transaction. Additionally or alternatively, method 300 can be much more efficient from the perspective of the user, who can complete most or all transaction steps while interacting with a graphical user interface for the offer 306 itself, for example, without being required to visit or open additional websites, app stores, and/or applications.

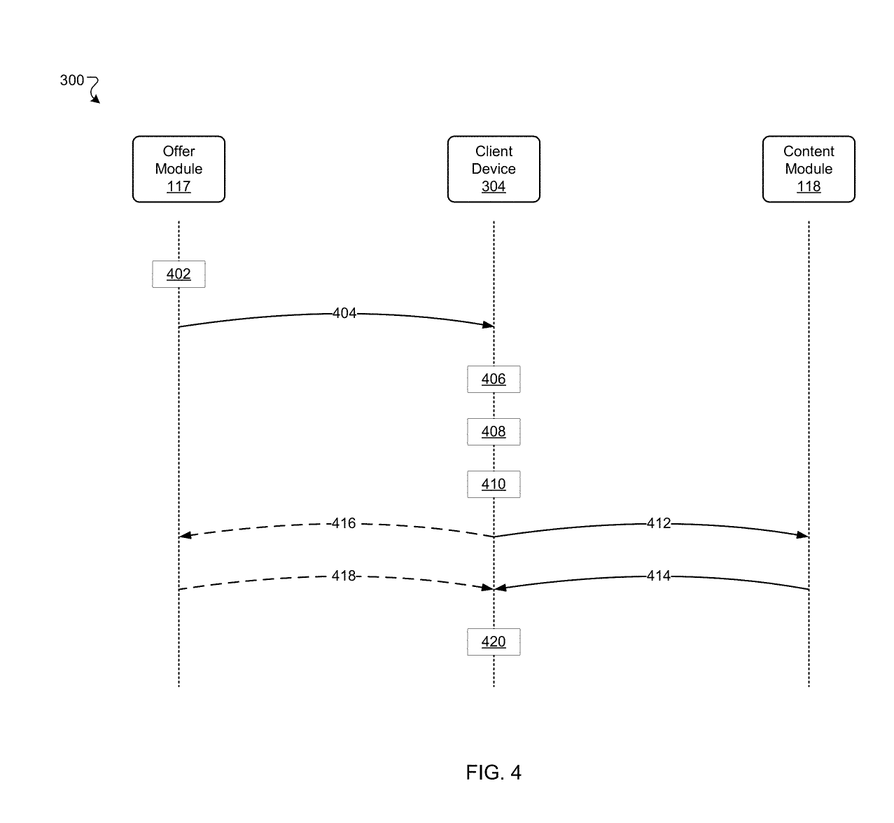

FIG. 4 is a schematic diagram showing how data can be processed by and transferred among the offer module 117, the client device 304, and the content module 118, during the performance of the method 300. The offer module 117 can begin by configuring (step 402) an offer (e.g., the offer 306 and/or the offer unit 142) for presentation on the client device 304. This can involve identifying specific content to be suggested to the user of the client device 304. Additionally or alternatively, configuring the offer can include determining any steps the user must take to receive the content, such as performing a task (e.g., watching a video, playing a support game or a mini game, etc.), making a payment, and/or completing a transaction associated with the offer. Once the offer (and/or the offer unit 142) has been configured, the offer (and/or the offer unit 142) can be sent (step 404) to the client device 304. The client device 304 can then display (step 406) the offer (e.g., as configured by the offer module 117), receive (step 408) acceptance of the offer, and facilitate (step 410) a transaction for the offer, as described herein. Once the transaction is finalized, the client device 304 can request (step 412) content (e.g., the content 310) from the content module 118, and the content module 118 can provide (step 414) the content to the client device 304. Alternatively or additionally, the client device can request (step 416) the content from the offer module 117, and the offer module 117 can provide (step 418) the content to the client device 304, for example, after retrieving the content from a database (e.g., the content data 120 database). The content can then be presented (step 420) on the client device 304.

In certain implementations, a user can complete a transaction associated with an offer by making a payment. The payment can be made using, for example, a credit or debit card, a mobile payment service (e.g., APPLE PAY or GOOGLE PAY), a digital wallet service, cryptocurrency (e.g., BITCOIN), a cryptocurrency wallet (e.g., METAMASK), blockchain, or any combination thereof. Header enrichment (e.g., MSISDN header enrichment) can be used to link a client device to a particular person and/or a particular financial account. In general, when a transaction for an offer involves a payment, the user can authorize the payment via a mobile wallet or the like, or can verify the purchase via another payment provider, which can involve inputting credit card details (e.g., from within an offer unit). After the payment is verified, the user can be directed to an appstore (or similar mobile marketplace) if the user needs to download a content provider's software application. Alternatively or additionally, the user can be directed to the content provider's software application (e.g., without first going to the appstore) or to the content provider's mobile website, to obtain the purchased content.

In some examples, offers and/or content can be configured for users according to certain user habits, interests, activities, histories (e.g., Internet browsing histories), geographical locations, and/or demographic features. For example, a user who previously visited a website related to movie content can receive an offer to receive the movie content. Likewise, a user who is visiting a geographical location can be presented with an offer to receive content (e.g., video and/or music) related to that location. Such user information can be stored in the user data 122 database. The offer module 117 and/or the offer unit 142 can access the user data 122 database to obtain the user information when configuring offers and/or content for specific users.

As described herein, the offer unit 142 can be configured to allow the user to perform all steps necessary to complete a transaction (e.g., offer acceptance, tasks, and/or transaction completion), preferably while interacting with a common graphical user interface (e.g., for the offer 306) and/or without having to visit any websites (e.g., online stores) or experience any network hops. For example, the offer unit 142 can be configured to receive certain information (e.g., name, address, payment information, etc.) from the user and/or to submit a payment (e.g., to a financial institution) for processing. The offer unit 142 can be configured to recognize when a purchase has been made, for example, when payment information has been submitted and payment confirmation has been received (e.g., from a financial institution or a content provider). Additionally or alternatively, the offer unit 142 can inform a content provider (e.g., by pinging a server for the content provider) that the payment has been made and/or the transaction has been completed. The offer unit 142 is preferably configured to coordinate communications to and from the offer unit 142, for example, between the user, the content provider, and/or any third parties or third party computer components. If the offered content will be delivered to a user's physical address, for example, the offer unit 142 can request and receive address information from the user and/or can share such address information with the content provider.

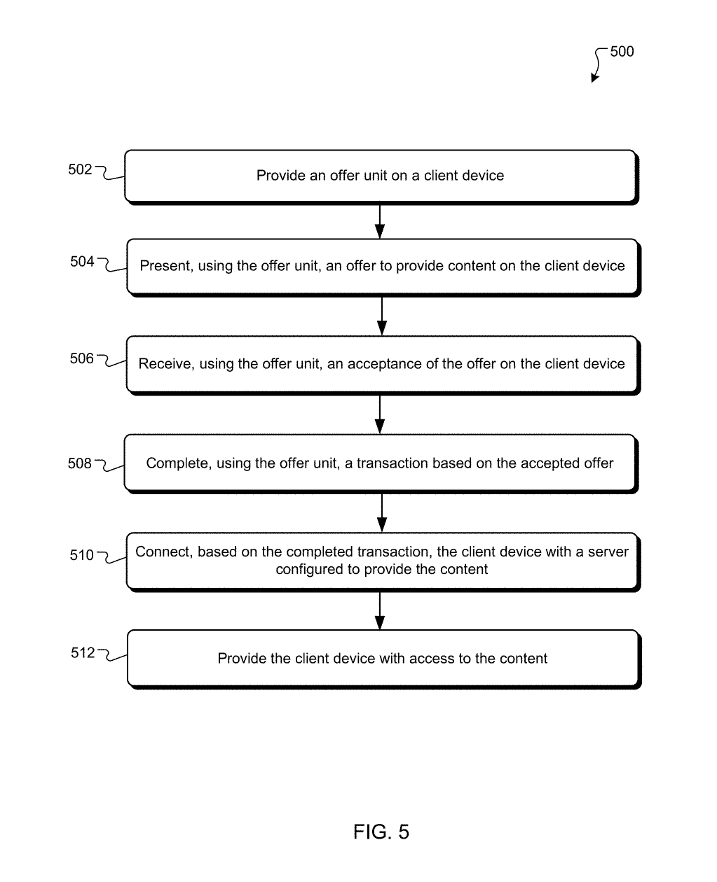

FIG. 5 illustrates an example computer-implemented method 500 of providing content on a client device. An offer unit (e.g., the offer unit 142) is provided (step 502) on a client device. The offer unit is used to present (step 504) an offer to provide content on the client device. The offer unit is used to receive (step 506) an acceptance of the offer on the client device. The offer unit is used to complete (step 508) a transaction based on the accepted offer. Based on the completed transaction, the client device is connected (step 510) with a server configured to provide the content. The client device is provided (step 512) with access to the content.

In certain implementations, the content (e.g., the content 310) can be or include a second offer for the user to receive second content (e.g., a second video, audio, images, game, text, or combinations thereof) on the client device. Like the original offer (e.g., offer 306), the second offer can be configured using the offer unit 142 and/or the offer module 117. To receive the second content, the user may be required to perform one or more tasks or complete a transaction associated with the second offer.

In various instances, the user can opt-into the second offer by interacting with the offer unit for the original offer. After opting-in, the user can be served the second offer, which can involve or include a transaction. In certain instances, a provider of the original offer can receive compensation (e.g., a payment) by selling the second offer to another provider. For example, when a user is in a publisher's app or on a publisher's mobile website, the user can be served a first offer to play a baseball mini game, in which the user attempts to hit a homerun. If the user fails to hit a homerun, the user can receive a second offer to play the mini game again. In such a case, a provider of the first offer can sell offer space to a provider of the second offer. Alternatively or additionally, the second offer can involve a transaction that allows the user to receive the second content associated with the second offer (e.g., by making a purchase using an offer unit for the second offer).

In some examples, when a user opts-into the second offer, the offer unit 142 can call a server for the second offer (e.g., the server system 112) and an offer module (e.g., the offer module 117) can provide the second offer and/or a corresponding second offer unit on the user's client device. Alternatively or additionally, the second offer can be provided and/or managed by the offer unit 142, which can track any user interactions with the second offer and/or report such interactions to the server.

Advantageously, the systems and methods described herein can allow users and/or content providers to more efficiently complete transactions associated with content offers. In general, the approach can reduce the number of steps, the number of network hops, and/or the computation times required to serve an offer and complete an associated transaction. Additionally or alternatively, a shorter feedback loop between serving the offer and completing the transaction can allow a content provider to more quickly and accurately determine or forecast a value of an offer served. In addition, the approach described herein can improve the user experience by simplifying the offer and transaction process. Users can experience less friction and are generally more likely to complete the transaction, without getting frustrated and/or abandoning the process.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., offer hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
providing an offer unit on a client device;
presenting, using the offer unit, an offer to provide content on the client device;
receiving, using the offer unit, an acceptance of the offer on the client device;
completing, using the offer unit, a transaction based on the accepted offer;
connecting, based on the completed transaction, the client device with a server configured to provide the content; and
providing the client device with access to the content.

2. The method of claim 1, wherein the offer unit is initiated from a first software application running on the client device.

3. The method of claim 1, wherein the offer unit comprises a graphical user interface configured to present the offer, receive the acceptance, and complete the transaction.

4. The method of claim 1, wherein the graphical user interface comprises at least one selectable graphical element.

5. The method of claim 1, wherein the content comprises at least one of a second software application, a video, an image, text, music, a game, and any combination thereof.

6. The method of claim 1, wherein the content comprises a second offer unit configured to present a second offer to provide second content on the client device.

7. The method of claim 1, wherein completing the transaction comprises:
determining that a user of the client device has performed a task in exchange for receiving the content.

8. The method of claim 1, wherein the server is configured to provide the content from at least one of a website and a third software application.

9. The method of claim 1, wherein providing the client device with access to the content comprises at least one of:
streaming the content to the client device; and
sending a content file to the client device.

10. The method of claim 1, further comprising:
configuring the offer based on at least one of a user habit, a user interest, a user activity, a user history, a geographical location, and a demographic feature of the user.

11. A system, comprising:
one or more computer processors programmed to perform operations comprising:
providing an offer unit on a client device;
presenting, using the offer unit, an offer to provide content on the client device;
receiving, using the offer unit, an acceptance of the offer on the client device;
completing, using the offer unit, a transaction based on the accepted offer;
connecting, based on the completed transaction, the client device with a server configured to provide the content; and
providing the client device with access to the content.

12. The system of claim 11, wherein the offer unit is initiated from a first software application running on the client device.

13. The system of claim 11, wherein the offer unit comprises a graphical user interface configured to present the offer, receive the acceptance, and complete the transaction.

14. The system of claim 11, wherein the graphical user interface comprises at least one selectable graphical element.

15. The system of claim 11, wherein the content comprises a second offer unit configured to present a second offer to provide second content on the client device.

16. The system of claim 11, wherein completing the transaction comprises:
determining that a user of the client device has performed a task in exchange for receiving the content.

17. The system of claim 11, wherein the server is configured to provide the content from at least one of a website and a third software application.

18. The system of claim 11, wherein providing the client device with access to the content comprises at least one of:
streaming the content to the client device; and
sending a content file to the client device.

19. The system of claim 11, wherein the operations further comprise:
configuring the offer based on at least one of a user habit, a user interest, a user activity, a user history, a geographical location, and a demographic feature of the user.

20. An article, comprising:
a non-transitory computer-readable medium having instructions stored thereon that, when executed by one or more computer processors, cause the computer processors to perform operations comprising:
providing an offer unit on a client device;
presenting, using the offer unit, an offer to provide content on the client device;
receiving, using the offer unit, an acceptance of the offer on the client device;
completing, using the offer unit, a transaction based on the accepted offer;
connecting, based on the completed transaction, the client device with a server configured to provide the content; and
providing the client device with access to the content.
